(19) United States
(12) Patent Application Publication
(10) Pub. No.: US 2018/0244876 A1
(43) Pub. Date: Aug. 30, 2018

(54) A ROBUST SMART FILM: REVERSIBLY SWITCHING FROM HIGH TRANSPARENCY TO ANGLE-INDEPENDENT STRUCTURAL COLOR DISPLAY

(71) Applicant: The Trustees of The University of Pennsylvania, Philadelphia, PA (US)

(72) Inventors: Shu YANG, Blue Bell, PA (US); Dengteng GE, Shanzhai (CN); Elaine LEE, Brooklyn, NY (US)

(21) Appl. No.: 15/553,805

(22) PCT Filed: Feb. 9, 2016
(86) PCT No.: PCT/US2016/017127

§ 371 Date: Aug. 25, 2017

Related U.S. Application Data
(60) Provisional application No. 62/127,275, filed on Mar. 2, 2015.

(51) Int. Cl. C08J 5/18; C08K 3/36; B32B 27/28; B32B 27/20

(52) U.S. Cl. CPC C08J 5/18; C08K 3/36; B32B 27/283; B32B 27/20; B32B 2383/00; C08J 2383/04; B32B 2250/02; B32B 2250/03; B32B 2264/102; C08K 2201/011

(57) ABSTRACT

Switchable optical materials, which possess reversible light transmission in response to external stimuli are of wide interest for potential applications such as energy efficient windows, roofings, and skylights that can transmit or block light. As described herein, a composite film containing nanoparticles (NPs) embedded in a polysiloxane was fabricated. It was completely transparent in the initial state due to refractive index match between NPs and polysiloxane. Upon mechanical stretching, the transmittance was dramatically reduced and displayed angle-independent structural color depending on the size of NPs. In each system, color switching mechanisms and their robustness against repeated mechanical stretching/release were evaluated. It was shown that these materials can be patterned for display hidden images.

### CROSS-REFERENCE TO RELATED APPLICATIONS

This application claims the benefit of the priority of U.S. Provisional Patent Application No. 62/127,275, filed Mar. 2, 2015, the disclosure of which is incorporated by reference.

### STATEMENT REGARDING FEDERALLY SPONSORED RESEARCH

The subject matter disclosed herein was made with government support under grant number EFRI-1038215 awarded by the National Science Foundation. The Government has certain rights in the herein disclosed subject matter.

### BACKGROUND

Commercial buildings in the US alone account for nearly 40% of the total energy consumption. Among them, electricity is the largest energy source for buildings. Therefore, the design of new energy efficient materials and technologies is crucial to meet goals such as the Net-Zero Energy Commercial Building Initiative (CBI) put forward by the U.S. Department of Energy (DOE). There has been tremendous interest in economizing energy uses in buildings through house roofing, skylights, and architectural windows. For example, smart windows have been developed, which become opaque to block or reflect sunlight on scorching days to save air conditioning costs, and return to a transparent state at a low lighting condition to improve light harvesting and capture free heat from the sun. Typically, optical-modulation in window or coating materials is realized through an external stimuli-triggered switch in chemistry and/or morphology to produce a change in optical properties, including the use of suspended particles, polymer dispersed liquid crystals (PDLCs), and chromogenic materials driven by ion and electron insertion/extraction, light, temperature, and electrical field. Often, the assembly of the device is complex, and many of the components are chemically unstable and costly.

Structural color resulting from the interference, diffraction and scattering of light from micro- or nano-structures with length scales on the order of the wavelength of light offers a promising alternative to dynamically tune the optical properties of materials in response to external stimuli without changing their bulk properties. In nature, bio-organisms switch color/opaqueness and/or transparency to suit the local environment for hiding from the predators, for signaling, or for mating purposes. For example, squids and octopus in deep sea are masters of disguise. They are normally transparent in sea, thus invisible to a predatory fish in downwelling light. They can quickly turn into red, however, thus become invisible again to fish with bioluminescent searchlights. They alternate the body color by stretching the skin to enlarge the embedded chromophores.

Mechanical modulation is a common practice to control light transmission macroscopically, such as the opening and closing of curtains and blinds. However, mechanical driving of macroscopic units is cumbersome and they must communicate through a mainframe. At the micro- and nano-scales, tuning of the optical properties by mechanical stretching and compressing has been demonstrated from patterned polymer thin films, including micro- and nanopillar arrays on wrinkled poly(dimethylsiloxane) (PDMS), shape memory polymers consisting of periodic microhole arrays and micro-optic components. Many of them have inherent, angle-dependent structural color due to Bragg diffraction from the periodic structures. Typically, the initial state is opaque or colored, attributed to the pre-existing micro/nanostructures. The windows exhibit increased transmission upon stretching due to the reduction of surface roughness, thus less scattering. However, the roughness of the materials and the resulting light scattering cannot be completely eliminated. Therefore, it is difficult to achieve high transparency with >90% transmittance in the visible region either before or after mechanical modulation.

What are needed in the art are film-like materials and devices that may be integrated into components to change transparency or color.

### SUMMARY

In one aspect, a composite film comprising a polysiloxane and nanoparticles is provided. The nanoparticles and polysiloxane of this film have substantially similar refractive indices, but a different Young's modulus of at least one order of magnitude. The reversibly exhibits different degrees of transparency depending on a stress applied to the film in the plane of the film, wherein the film transmits at least 90% of light in a first, less stressed state and the film transmits less light in a second, more stressed state than when in the first state.

In another aspect, a composite film comprising nanoparticles embedded within a polysiloxane is provided, where the nanoparticles and polysiloxane have matched refractive indices within 5%. The film has first and second surfaces, the nanoparticles being concentrated closer to the first surface than the second surface. The film reversibly exhibits different degrees of transparency depending on a stress applied to the film in the plane of the film, such that when in a first, less stressed state, the film transmits at least about 90% of incident light, and when in a second, more stressed state, the film transmits less light than when in the first state.

In a further aspect, a reversibly deformable and transparency-modifiable film is provided and comprises a first layer of poly(dimethylsiloxane) and a second layer of poly(dimethylsiloxane) impregnated with silica nanoparticles.

In still another aspect, a laminate structure is provided and includes substantially transparent base layer and a film as described herein adjacent to said base layer.

In yet a further aspect, a switchable optical laminate is provided and includes a film as described herein.

In another aspect, a process for preparing composite film described herein is provided and includes curing the polysiloxane with nanoparticles on a substrate.

In still a further aspect, a process for modulating light transmission through glass is provided and includes positioning a film described herein in front or behind the glass.

In yet another aspect, a composite film structure is provided and contains a film described herein superposed on a second film.

In a further aspect, a multilayer object is provided and includes at least one layer comprising a film described herein.

Other aspects and embodiments of the invention will be readily apparent from the following detailed description of the invention.

### BRIEF DESCRIPTION OF THE DRAWINGS

The present application is further understood when read in conjunction with the appended drawings. For the purpose of illustrating the subject matter, there are shown in the drawings exemplary embodiments of the subject matter; however, the presently disclosed subject matter is not limited to the specific compositions, methods, devices, and systems disclosed. In addition, the drawings are not necessarily drawn to scale.

FIG. 1(a) is a schematic of the fabrication process as described herein to prepare the films. FIG. 1(b) are digital photographs of the films prepared with nanoparticles of diameters (i) 221, (ii) 258, and (iii) 306 nm. FIG. 1(c) is a SEM image of the film showing quasi-amorphous ordering. FIGS. 1(d) and (e) are a digital photograph and SEM image of the highly transparent silica/PDMS composite film. FIG. 1(f) are digital photographs of stretched silica/PDMS films with embedded nanoparticles of diameters (i) 221, (ii) 258, and (iii) 306 nm, respectively.

FIGS. 2(a)-(b) provide optical micrographs of a silica/PDMS film containing nanoparticles of diameter 258 nm at various strains in (a) reflection and (b) transmission modes (scale bars: 20 μm). FIG. 2(c) is a SEM image of a stretched silica/PDMS film with nanoparticles of diameter 258 nm at about 80% strain. Arrows indicate PDMS ligaments. FIG. 2(d) is a confocal optical micrograph of (i) an un-stretched and (ii) a stretched silica nanoparticle (diameter of 5 μm)/PDMS film. Circles indicate silica nanoparticles and black regions indicate the voids.

FIG. 3(a) are digital photographs of a silica/PDMS film containing nanoparticles of diameter 258 nm at various strains. FIG. 3(b) are transmittance spectra of a pure PDMS film (black), an as-prepared silica nanoparticle/PDMS film (green), and a silica nanoparticle/PDMS film stretched at 100% strain (blue) and released (red) 1000 times. The inset shows transmittance change as a function of stretching/release cycles. FIG. 3(c) are spectra showing transmittance vs. strain at wavelengths of 500 nm and 700 nm, respectively. FIG. 3(d) are reflectance spectra of the composite film with nanoparticle diameter of 258 nm at various strains at a viewing angle of 10°. The inset is a schematic illustration of the viewing angle in the experimental setup. FIG. 3(e) are reflectance spectra of silica nanoparticle/PDMS films with 80% strain at a viewing angle of 10°. The nanoparticles have diameters of (i) 221, (ii) 258, and (iii) 306 nm, respectively. The inset includes optical micrographs of the stretched silica/PDMS membrane with nanoparticles of diameter of (i) 221, (ii) 258, and (iii) 306 nm, respectively (scale bars: 20 μm). FIG. 3(f) are reflectance spectra of the composite film with nanoparticle diameter of 258 nm with 80% strain at various viewing angles.

FIG. 4(a) is a schematic illustration of the void formation around the silica particles when stretched. The arrows indicate PDMS ligaments. FIG. 4(b) are images of reversibly revealing and hiding the letters patterned within the silica nanoparticle/PDMS film under mechanical stretching and releasing.

FIG. 5 provides the transmission spectra of silica nanoparticle/PDMS composite films at various strains. The silica nanoparticles have diameters of (a) 221 nm, (b) 258 nm, and (c) 306 nm.

FIG. 6 provides the reflectance spectra of as-prepared silica nanoparticle arrays with diameters of (a) 221 nm, (b) 258 nm, and (c) 306 nm, respectively.

FIG. 7(a) is a schematic of a stretched silica/PDMS composite film with a single particle. FIG. 7(b) is a graph illustrating the relationship of strain and volume filling fraction of void.

### DETAILED DESCRIPTION

In summary, smart films are discussed herein and are advantageously and unexpectedly optically switchable. The terms “smart” or “switchable” when used herein to describe the films of the invention refer to the ability of the same to change light transmission properties under the application of strain, voltage, light or heat. The films modulate the amount of light, and thereby heat, transmission, or a combination thereof. When activated, the film changes from translucent to transparent or vice versa, changing from blocking some or all of light to letting light pass through.

The transparency of the films may be reversibly switched by effecting, increasing, decreasing, or removing a strain. In one embodiment, the transparency of the films may be reversibly switched from a highly transparent state to opaqueness or may display angle-independent reflective colors.

The films are also tunable to display a specific color, if so desired. Displayed colors are dependent on the size of the nanoparticles. The displayed colors may also be blue-shifted compared to the films prepared from nanoparticles only. It is hypothesized that the dramatic change of optical responses is attributed to an increase of diffused light scattering and absorption resulting from the formation of microwrinkles and voids during stretching the films.

The design of the films discussed herein offers a facile, easily prepared, easily implemented and low cost approach to dynamically and dramatically change optical properties. The films, thereby, have application in a wide number of technologies such as electrochromic, photochromic, thermochromic, suspended particle, micro-blind and liquid crystal devices. The films also may be mass-produced using abundant materials, further contributing to their low cost.

Advantageously, the initial state of the film is transparent, whereas most smart windows in the art are opaque or colored in the original state as noted above. Therefore, the films may be find use in windows, displays, camouflages, security, heat/solar gain control, liquid crystal elastomers, shape memory polymers, and highly responsive, nano-/microstructured materials that are sensitive to heat, light and moisture either as a “wallpaper” or separate component. Accordingly, the films care capable of modulating climates, thereby saving costs for heating, air-conditioning and lighting and the consumers the cost of installing and maintaining motorized light screens or blinds or curtains, oftentimes repeatedly based on the wear and tear of the technology.

As noted above, the physical properties of the films described herein may be dynamically and dramatically changed when subjected to a strain. The films described herein are capable of controlling light transmission and, thereby, can regulate the amount of light passing through the same. The smart films described herein have some or all of the following unique characteristics:
(i) Prior to inducing strain, the film in its initial state truly is transparent, whereas most smart windows are opaque or colored in the original state.
(ii) The change of transmittance in the vis-NIR region is very large.
(iii) The films offer angle-independent color display upon stretching whereas most stretchable smart windows display angle-dependent colors.
(iv) The displayed color for the film is independent of strain.
(v) The films are highly robust in repeated stretching and releasing, particularly in comparison to highly ordered colloidal crystals.
(vi) The switch between transparency and colored states may be reversibly cycled without losing the film's structural and optical integrity.

The present invention may be understood more readily by reference to the following description taken in connection with the accompanying Figures and Examples, all of which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, unless otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer both to the features and methods of making and using the coatings and films described herein.

In the present disclosure the singular forms “a”, “an” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about” or “substantially” it will be understood that the particular value forms another embodiment. In general, use of the term “about” or “substantially” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about” or “substantially”. In other cases, the gradations used in a series of values may be used to determine the intended range available to the term “about” or “substantially” for each value. Where present, all ranges are inclusive and combinable. That is, references to values stated in ranges include every value within that range.

When a list is presented, unless stated otherwise, it is to be understood that each individual element of that list and every combination of that list is to be interpreted as a separate embodiment. For example, a list of embodiments presented as “A, B, or C” is to be interpreted as including the embodiments, “A,” “B,” “C,” “A or B,” “A or C,” “B or C,” or “A, B, or C.”

It is to be appreciated that certain features of the invention which are, for clarity, described herein in the context of separate embodiments, may also be provided in combination in a single embodiment. That is, unless obviously incompatible or excluded, each individual embodiment is deemed to be combinable with any other embodiment(s) and such a combination is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation. Finally, while an embodiment may be described as part of a series of steps or part of a more general structure, each said step may also be considered an independent embodiment in itself.

The term “light” as used herein refers to infrared (including near-infrared), visible, ultraviolet light, or any combinations thereof. Visible light refers to that portion of the electromagnetic spectrum that is visible to or can be detected by the human eye, typically wavelengths from about 390 to about 700 nm. Infrared light is that light having wavelengths higher than the high end of this range (i.e., about 700 nm to about 1 m) and ultraviolet refers to light having wavelengths at wavelengths lower than the low end of this range (i.e., about 10 to about 400 nm).

The base components of the films described herein include nanoparticles and a polysiloxane. The type of film prepared is based on the selection of the nanoparticles and polysiloxane. The inventors found that the refractive indices of the nanoparticles and polysiloxane are may be matched in order to obtain one or more of the advantageous described above. As known in the art, a refractive index is indicative of much light is bent, or refracted, when entering a material at one baseline wavelength. The term “matched” as used herein refers to refractive indices that vary by no more than about 10% using the techniques described in Raman (Phys. Proc. 2011, 19:146) and Malitson (J. Opt. Soc. Am. 1965, 55:1205), which are incorporated by reference. In one embodiment, the refractive indices of the nanoparticles and polysiloxane vary by no more than about 5%, no more than about 4%, no more than about 3%, no more than about 2%, or no more than about 1%. One of skilled in the art would readily be able to select a suitable polysiloxane based on the selected nanoparticles, and vice versa. In one embodiment, the refractive indices of the nanoparticles and polysiloxane are about 1 to about 2 at a wavelength of about 632 nm.

It also is contemplated that the nanoparticles and polysiloxane have a different Young's modulus of at least one order of magnitude.

The nanoparticle sizes and distributions described may be characterized separately in terms of their ability to transmit light, when incorporated in a film as described herein. In such independent embodiments, the nanoparticles are of a size and distribution so as to transmit light at varying transmissions. The nanoparticles may be assembled in any form including random, quasi-amorphous and ordered structures. By doing so, the films can be tuned to be opaque, opaque/angle-independent color, opaque/angle-dependent colors, or combinations thereof.

The term “nanoparticle” refers to a particle having at least one dimension in the nanoscale dimension (i.e., a mean diameter) of about 1 nm to about 10 μm. The terms “mean diameter” or “mean cross-sectional dimension” refers to the arithmatic average of the lengths of the major and minor axes of the particles. However, certain embodiments contemplate a narrower particle size range. That is, in certain embodiments, at least some of the plurality of nanoparticles has a mean diameter of about 5 nm to about 300 nm. In other embodiments, substantially all of the nanoparticles in the film have a mean cross-sectional dimension within this range. In separate embodiments, the film comprises a plurality of particles having a mean cross-section dimension or diameter in a range independently bounded at the lower end of the range by 1 nm, 5 nm, 10 nm, 15 nm, 20 nm, or 25 nm, and at the upper end of the range by 1000 nm, 300 nm, 250 nm, 200 nm, 175 nm, 150 nm, 125 nm, or 100 nm. Other embodiments within these ranges include those ranges of from 5 to 200 nm, from 5 to 50 nm, from 10 to 200 nm, or from 150 to 200 nm.

In one embodiment, the nanoparticles are ordered and have a mean cross-sectional dimension of up to about 20 μm, thereby resulting in an iridescent color when stressed. In another embodiment the nanoparticles are randomly packed and have a mean diameter of up to about 500 μm, thereby resulting in an opaque film. In a further embodiment, the nanoparticles are ordered, quasi-amorphous, and random and have a mean cross-section dimension of about 50 to about 180 nm, thereby resulting in a combined blue color (from Rayleigh scattering) and white color from random scattering. In yet another embodiment, the nanoparticles are quasi-amorphous and have a mean cross-sectional dimension of about 180 to about 320 nm, thereby displaying a uniform color (blue, green, light yellow) from scattering. In a further embodiment, the nanoparticles are large and cause strong scattering, thereby resulting in the observance of a weak color. In still another embodiment, the nanoparticles have a mean cross-sectional dimension of about 180 to about 320 nm, thereby resulting in an iridescent color (purple to red) from scattering. In still yet another embodiment, the nanoparticles are quasi-amorphous and random and have a mean cross-sectional dimension of about 320 to about 500 μm, thereby displaying no color, but are white due to scattering from the particle surface. In a further embodiment, the nanoparticles are ordered and have a mean cross-section dimension of about 320 nm to about 10 μm, thereby displaying iridescent color in the visible to IR wavelength and whiteness due to scattering. In yet a further embodiment, the particles have any structure and a mean cross-sectional dimension of about 10 μm to about 500 μm, thereby displaying no color, but whiteness due to scattering.

The nanoparticles may be of any shape. In one aspect, the aspect ratio between the major and the minor axes of the particles is about 1 to about 10. Non-limiting examples include needles, cubic, tetrahedral, octahedral, icosahedral, oblate spheroid, or substantially spherical. To the extent that a given particle or population of particles deviates from a purely spherical shape, such that each particle can be described as having a major and minor axis, the present application includes embodiments wherein the ratio of the lengths of the major and minor axis of each particle can be about 2, less than 2, less than 1.5, less than 1.3, less than 1.2 or less, less than 1.1, or less than 1.05 or less than 1.02, for example, to 1. The term “substantially spherical” refers to a shape wherein the ratio of major/minor axis less than 1.1. Similarly, where the particles are other than purely spherical, the term “mean diameter” or “mean cross-sectional dimension” refers to the arithmatic average of the lengths of the major and minor axes of the particles.

The nanoparticles, therefore, are selected based on the desired film and properties of same desired. In one embodiment, the nanoparticles are silica, polymethylmethacrylate, polystyrene, or combinations thereof. The silica particles may be optionally surface functionalized with hydrophobic groups such as fluorinated aliphatic groups such as —(CH₂)ₙ(CF₂)ₘCF₃, alkyl groups such as —(CH₂)ₙCH₃, aromatic moieties, or combinations thereof. In another embodiment, the nanoparticles comprise polymethylmethacrylate, polystyrene, or combinations thereof or with silica.

The polysiloxane is selected based on the selected nanoparticles. The amount of crosslinking in the selected polysiloxane should not be considered a limitation on the present invention. Accordingly, the films may be prepared using non-crosslinked or crosslinked polysiloxanes. If crosslinking is present, it may be if any crosslinking required to effect the desired transparency. In one embodiment, the polysiloxane is lightly crosslinked or highly crosslinked. The term “lightly” as used herein refers to the polysiloxane having no more than about 20 mol % of crosslinking. In another embodiment, the polysiloxane is substantially deformable at room temperature. The term “substantially deformable” as used herein refers to the ability of the polysiloxane to form another shape at room temperature or at elevated temperatures which may readily be determined by one skilled in the art. In one embodiment, the polysiloxane is a shape memory polymer.

The terms “polysiloxane” and “silicone” are utilized herein interchangeably to describe polymers containing repeating [R₂SiO] groups, wherein R is an organic moiety and may be independently chose for each unit. By varying the R groups, SiO chain lengths, and crosslinking, the films may be tailored dependent on the properties desired by the film. In one embodiment, the polysiloxane is a poly(dimethylsiloxane). In another embodiment, the polysiloxane is available from Down Corning as the Sylgard® silicone elastomer (containing one or more of ethylbenzene, xylene, dimethylvinyl-terminated dimethylsiloxane, dimethylvinylated and trimethylated silica, tetra(trimethylsiloxy)silane), and octamethylcyclotetrasiloxane), the Dow Corning® 3145 RTV MIL-A-46146 product (containing one or more of dimethylvinyl-terminated dimethylsiloxane, amorphous silica, hydroxyl-terminated dimethylsiloxane, dimethylvinyl-terminated diethyl, methylvinyl siloxane, and dimethylcyclosiloxanes), the Dow Corning® C6-150 elastomer (containing one or more of the reaction product of hexamethyldisilazane with silica, methyltriethoxysilane, ethanol, and octametylcyclotetrasiloxane, dimethyldimethoxysilane), the NuSil silicones including the LS12-3354 product, the silicones discussed in Norris (“Silicone Materials Development of LED Packaging”, Electronic Solutions, Dow Corning available from www.dowcorning.com/content/etronics/LED.asp), which is incorporated by reference, among others. The polysiloxane may be combined with one or more additional elastomer, provided that the resultant flow properties, refractive index, and Young's modulus of the polysiloxane are not affected. In one embodiment, the polysiloxane may be combined with liquid crystal elastomers such as those described in Lazo (Determination of Refractive Indices of Liquid Crystal Elastomer”, Liquid Crystal Institute, American Physical Society, 2008), which is incorporated by reference, thermoplastic elastomers such as ethylene-vinyl acetate, thermoplastic polyurethane, poly(styrene-butadiene-styrene), among others.

It further is contemplated that additional components or additives may be included in the films described herein and include, without limitation, piezoelectric agents, pigments, fillers, antistatic agents, anti-fogging agents, dispersing additives, odor absorber, slip additives, adhesion promoters; antioxidants, biocides, antibacterials, fungicides, mildew inhibitors, bonding agents, blowing agents, foaming agents, dispersants, extenders, smoke suppressants, impact modifiers, initiators, lubricants, plasticizers, processing aids, other polymers, release agents, stabilizers, ultraviolet light absorbers, viscosity regulators, or combinations thereof. In one embodiment, a piezoelectric agent may be included. By doing so, a strain may be induced on the film using an electrical field.

The films described herein are prepared by forming a film composition on a substrate, where the film composition contains the components identified for the film. The term “substrate” as used herein refers to a template which temporarily or permanently is attached to the film. The type of substrate may be selected by one skilled in the art depending on the potential application of the film. In one embodiment, the substrate is temporary and not intended to operate with the film. In another embodiment, the substrate is permanent and is utilized in conjunction with the film. In a further embodiment, the substrate is glass, plastic, or the like. In still another embodiment, the substrate is polystyrene. In cases where the film is not directly affixed to the substrate when in use, either side of the film may face the substrate. The film may also be sandwiched in between 2 substrates such as two pieces of glass (such as panes), plastic, or the like.

The film may be comprised of one layer or of several layers. In one embodiment, the film is comprised of at least two layers. In a further embodiment, the film is comprises of one layer containing polysiloxane and a second layer containing polysiloxane/nanoparticles. In another embodiment, the film is comprised of at least three layers. In yet a further embodiment, the film is comprised of a polysiloxane/nanoparticle middle payer with two outside layers comprising polysiloxane. The inventors hypothesize that the three-layer film may offer additional protection of the nanoparticle/polysiloxane composite layer. The layers may be the same or different thicknesses. In one embodiment, one of the layers has a thickness of about 100 μm to about 1 mm.

The film composition may be prepared by mixing the nanoparticles and the polysiloxane prior to curing. In another embodiment, the film composition may be prepared by depositing the nanoparticles onto a substrate and depositing the polysiloxane over the nanoparticles. In a further embodiment, the film composition may be prepared by depositing the polysiloxane on a substrate and depositing the nanoparticles on the polysiloxane. Variations and combinations of these layering techniques may be utilized based on the desired film, selected particles, and selected polysiloxane.

Each layer of the film composition may be substantially dried prior to depositing the next layer. Alternatively, the layers may be applied to each other in a wet form. The term “substantially dried” means that the layer contains no more than about 10% of a liquid. In one embodiment, the layer contains no more than 10% of the solvent. The time required to dry each or all layers may vary and is dependent upon the nanoparticles, polysiloxane, solvent(s), among others.

The polysiloxane may be utilized in the presence of absence of a cross-linking agent. The terms “cross-linking agent” and “curing agent” are utilized interchangeably to describe an agent which facilitates crosslinking of the polysiloxane. A variety of cross-linking agents may be selected by one skilled in the art and depends on the polysiloxane included in the film composition. The cross-linking agent may be purchased together with the polysiloxane or separately for combining with the polysiloxane at the time of use. One of skill in the art would be able to select a suitable cross-linking agent such as platinum-based cross-linking agent, a condensation reaction-based cross-linking agent, a peroxide cure-based cross-liking agent, an oxime cure-based cross-linking agent, or combinations thereof. The amount of cross-linking agent included in the film composition also is dependent on the selected polysiloxane. The decision to use a cross-linking agent and selection thereof is dependent on the cross-linking properties of the selected polysiloxane and any additional elastomers combined therewith. In one embodiment, the polysiloxane solution optionally containing one or more additional elastomer may require a crosslinking agent to toughen or harden the same. In one embodiment, the weight ratio of cross-linking agent to polysiloxane is about 1 to about 10. In instances where a cross-linking agent may not be utilized, curing may be accomplished by cooling the film to room temperature, using heat or using an electrical source.

The nanoparticles are dispersed in a solvent which is selected based on the physical structure of the nanoparticles. When it is desired that the nanoparticles have a random arrangement in the film, any number of solvents may be selected by one skilled in the art, including volatile solvents. Alternatively, when it is desired that the nanoparticles have an ordered arrangement in the film, higher boiling point solvents may be utilized. A higher boiling point solvent evaporates slowly, thereby permitted in the articles to assemble into an equilibrium state prior to hardening. High boiling point solvents may be selected by those skilled in the art and include, without limitation, water, 2-butoxyethanol, ethylene glycol, or combinations thereof.

In certain embodiments of the present invention, a volatile solvent refers to a solvent, generally a polar solvent, able to disperse the aforementioned nanoparticles. In sprayable compositions, the solvent is capable of quickly drying, thus leaving a uniform coating. The solvent also is capable of evaporating at ambient conditions alone or in combination with other factors which expedite evaporation. Examples of other factors which expedite evaporation in include air flow, heat, pressures, among others.

In other embodiments, the solvents include C₁₋₄ alcohols or polyglycols. Accordingly, in certain other embodiments, the solvent comprises at least one C₁₋₄ alcohol. Some amount high boiling point solvent may be useful in tuning the evaporation speed. In one embodiment, volatile solvents may be utilized, especially for such sprayable coating compositions. The solvent may also comprise added water, to the extent that the concentration does not compromise the volatility of the solvent. In separate embodiments, the solvent may also contain one or more higher boiling solvent, such as 2-butoxyethanol, which has been used in existing spray type cleaner, to tune the volatility of the coating, thus, the uniformity of the coating. Sprayable compositions may also contain hydrocarbons (e.g., propane and n-butane (1-3%)) or other propellants may also be used as a dispersant. If films are prepared using drop casting, spin coating, centrifugation, sedimentation, or a combination thereof, a higher boiling point solvent may be selected.

The nanoparticle solution is mixed using techniques known to those skilled in the art including, without limitation, sonication, for a time sufficient to form a solution having substantially uniform nanoparticles dispersed there through. In one embodiment, the nanoparticles are dispersed in the solvent for about 2 hours. The nanoparticle solution then is applied to a substrate using techniques in the art including brush coating, (sol-gel) dip coating, drop-casting, spin coating, and spray coating. In particular, the present compositions films are especially prepared by spray coating. The nanoparticle solution may be applied in a single pass or several passes on the substrate. In one embodiment, the nanoparticle solution was sprayed 4 times on the substrate. On of skill in the art would be able to determine the thickness of the nanoparticle layer and is based on the selected nanoparticle, application technique, among others. The nanoparticle solution was then permitted to dry, i.e., permit evaporation of the volatile solvent.

The polysiloxane, and cross-linking agent, if necessary, was then deposited onto the nanoparticle composition layer. In doing so, the polysiloxane infiltrates into the voids of the nanoparticle film. The thickness of the polysiloxane layer may be controlled and is dependent on the particular polysiloxane selected. In one embodiment, the thickness of the polysiloxane layer is about 0.1 mm to about 5 mm. In another embodiment, the thickness of the polysiloxane layer is about 0.5 mm to 1 mm.

Once applied, the compositions provide a pre-cured coating. If necessary, the combined layers are cured using techniques and skill in the art. In some embodiments, the curing may be accomplished using heating. In other embodiments, the curing is accomplished using radiant energy (e.g., UV light), depending on the components of the film. That is, in various embodiments, the methods of preparing films further include applying sufficient energy for a sufficient time to the pre-cured coating so as to convert the pre-cured coating layer to a film. The term “thermal curing” is intended to connote application of heat so as to raise the temperature of the coating to one higher than that used for drying (e.g., the latter being about 40° C. to about 80° C.).

The temperature, if required, and time required during the curing process is dependent on the polysiloxane, nanoparticle, solvent(s), cross-linking agent, laboratory conditions, among others. The temperature must be low enough, however, to avoid degradation or unwanted reactions of the components of the compositions and/or the final film product. Accordingly, the curing may be performed at room or elevated temperatures. In one embodiment, the curing is a dehydration of the pre-cured coating, the heating may be done in either air or under inert atmosphere. As described herein, the energy may include thermal energy. In one embodiment, the curing may be performed at about 20 to about 80° C. In another embodiment, the curing is performed at about room temperature. In a further embodiment, the curing is performed at about 25 to about 65° C. The curing is performed for a time sufficient to result in a solidified film. In one embodiment, curing is performed about 1 minute to about 24 hours. In another embodiment, the curing is performed for about 1 to about 4 hours.

Once the film is formed, i.e., the composition has solidified, the film may be removed from the substrate. Alternatively, the film is retained on the substrate. One of skill in the art would be able to remove the film using techniques known in the art including peeling.

As discussed above, the films described herein have a wide range of applications requiring modulation of light transparency. Accordingly, the light transparency modulation is accomplished by applying a strain to the film. The inventors, in fact, found that the films are highly robust in repeated stretching and releasing. In one embodiment, strain may be applied to the films at least about 500 times, at least about 1000 times, at least about 2000 times before the integrity of the films is altered.

Based on the spectroscopic analyses described below, the films contain at least two layers. One layer includes a mixture of polysiloxane and nanoparticles, while the second layer substantially contains polysiloxane alone. Accordingly, the majority of the film under the induced strain is due to the polysiloxane in the film. In fact, it is hypothesized that the strain is mainly affected by polysiloxane layer of the film. The spectroscopic data also notes that the second layer contains pores when subjected to strain. The pores may be large or small, depending on the selected nanoparticles and polysiloxane. Large pores may be defined as those having a size of 500 μm in diameter or less.

The term “strain” as used herein refers to the application of a mechanical stretch on the film along one or more axis. Strain may be measured using a number of techniques known to those skilled in the art including, without limitation, a caliper. In one embodiment, the strain is applied along one axis. The amount of strain required to achieve the desired transmittance variation depends on the selected polysiloxane and nanoparticles, among other factors, including those discussed above. In one embodiment, the film is stretched at least about 10% along one axis. In another embodiment, the film is stretched at least 10%, at least 20%, at least 30%, at least 40%, at least 50%, at least 60%, at least 70%, at least 80%, or at least 90% along one axis. In a further embodiment, the strain is about 10 to about 20% for ordered structures.

In one embodiment, the amount of strain applied to the film is inversely proportional to the transparency. For example, the film is substantially transparent at 0% strain. However, a significant reduction in transmittance is initiated at a strain of at least about 20%. In one embodiment, a significant reduction in transmittance is initiated at a strain of at least about 30%. In another embodiment, light transmittance is substantially eliminated at a strain of about 70%. In a further embodiment, the film it was highly transparent (i.e., greater than about 90% transmittance in the visible wavelength) with 0% strain and, upon mechanical stretching, the transmittance was dramatically reduced to about 30% and displayed angle-independent structural color at a strain of greater than about 40%.

The strain may be applied to using any technique required for the particular application of the film and as determined by those skilled in the art. In one embodiment, the strain is applied using a mechanical force such as physical stretching. In other embodiments, the strain is applied using or piezoelectric stretching. The mechanical force may be driven by any means required to apply the proper strain. In some embodiments, the mechanical force is drive by a motor, lever, or combination thereof.

In another embodiment, a portion of the film is stabilized or bound to a stationary object. For example, the film may be enclosed in a frame in the shape of the film. The frame may be a specific size or expandable to permit inducing strain on the film my stretching.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described herein.

The following listing of embodiments in intended to complement, rather than displace or supersede, the previous descriptions.

### Embodiment 1

A composite film comprising a polysiloxane and nanoparticles, wherein the nanoparticles and polysiloxane have substantially similar refractive indices, but a different Young's modulus of at least one order of magnitude; the film reversibly exhibiting different degrees of transparency depending on a stress applied to the film in the plane of the film, wherein the film transmits at least 90% of light in a first, less stressed state and the film transmits less light in a second, more stressed state than when in the first state.

### Embodiment 2

A composite film comprising nanoparticles embedded within a polysiloxane, the film having first and second surfaces, the nanoparticles being concentrated closer to the first surface than the second surface, wherein the nanoparticles and polysiloxane have matched refractive indices within 5%; the film reversibly exhibiting different degrees of transparency depending on a stress applied to the film in the plane of the film, such that when in a first, less stressed state, the film transmits at least 90% (average in the visible wavelength range) of incident light, and when in a second, more stressed state, the film transmits less light than when in the first state.

### Embodiment 3

A reversibly deformable and transparency-modifiable film comprising a first layer of poly(dimethylsiloxane) and a second layer of poly(dimethylsiloxane) impregnated with silica nanoparticles.

### Embodiment 4

The film of Embodiment 1 or 2, wherein the polysiloxane is lightly cross-linked.

### Embodiment 5

The film of Embodiment 1 or 2, wherein the polysiloxane is deformable at a temperature of at least room temperature.

### Embodiment 6

The film of Embodiment 1 or 2, wherein the polysiloxane is a poly(dimethylsiloxane).

### Embodiment 7

The film of Embodiment 1 or 2, wherein the nanoparticles are highly ordered.

### Embodiment 8

The film of any one of Embodiments 1 to 3, wherein the aid nanoparticles are quasi-amorphous.

### Embodiment 9

The film of Embodiment 1 or 2, wherein the nanoparticles are silica particles, polystyrene particles, poly(methyl methacrylate) particles, or a combination thereof.

### Embodiment 10

The film of Embodiment 9, wherein the silica particles are functionalized with hydrophobic groups.

### Embodiment 11

The film of Embodiment 10, wherein the hydrophobic groups comprise —(CH₂)ₙ(CF₂)ₘCF₃, —(CH₂)ₙCH₃ and aromatic moieties.

### Embodiment 12

The film of Embodiment 1, having first and second surfaces, wherein the nanoparticles are concentrated closer to the first surface than the second surface.

### Embodiment 13

The film of Embodiment 12, having anisotropy from one surface of the second layer to a second surface thereof.

### Embodiment 14

The film of Embodiment 13, wherein the anisotropy is visible using scanning electron microscopy.

### Embodiment 15

The film of Embodiment 12, wherein the second layer has a thickness of about 2 to about 20 μm.

### Embodiment 16

The film of Embodiment 12, wherein the first layer has a thickness of about 0.1 to about 1 mm.

### Embodiment 17

The film of Embodiment 12, having pores in the second layer when subjected to a strain of at least about 40% uniaxially in the plane of the film.

### Embodiment 18

The film of Embodiment 17, wherein the pores are large.

### Embodiment 19

The film of any one of Embodiments 1 to 3, which transmits at least about 90% of light at a wavelength of about 400 nm to about 1000 nm at 0% strain.

### Embodiment 20

The film of any one of Embodiments 1 to 3, wherein the nanoparticles have a diameter of about 100 nm to about 5 μm.

### Embodiment 21

The film of any one of Embodiments 1 to 3, wherein the nanoparticles have a mean diameter of about 220 to about 310 nm.

### Embodiment 22

The film of any one of Embodiments 1 to 3, wherein the nanoparticles have a substantially uniform diameter.

### Embodiment 23

The film according to any one of Embodiments 1 to 3, wherein the nanoparticles have excursions within about 10% of the nominal diameter.

### Embodiment 24

The film of any one of Embodiments 1 to 3, which is in contact with an electrical control circuit to apply mechanical strain to the film.

### Embodiment 25

The film of any one of Embodiments 1 to 3, further comprising a piezoelectric agent.

### Embodiment 26

The film of any one of Embodiments 1 to 3, further comprising a shape which is visible in a higher stress state and invisible in a lower stress state.

### Embodiment 27

The film of Embodiment 26, wherein the shape substantially absorbs and scatters incident light.

### Embodiment 28

The film of Embodiment 26, wherein shape is a letter, number, symbol, illustration, or combination thereof.

### Embodiment 29

The film of any one of Embodiments 1 to 3, wherein the light is ultraviolet, visible, or infrared.

### Embodiment 30

The film of any one of Embodiments 1 to 3, wherein the light is incident or reflective.

### Embodiment 31

The film of any one of Embodiments 1 to 3, which is mounted in a frame.

### Embodiment 32

The film of any one of Embodiments 1 to 3, wherein the frame induces strain on the film.

### Embodiment 33

The film of Embodiment 32, wherein the strain is induced by a mechanical force.

### Embodiment 34

The film of Embodiment 33, wherein the mechanical force is driven by a motor or a lever.

### Embodiment 35

The film of Embodiment 1, wherein the mean particle size of the nanoparticles is selected to result in a preselected reflected color upon application of a strain to the film.

### Embodiment 36

A laminate structure comprising a substantially transparent base layer and a film of any one of Embodiments 1 to 3 adjacent to the base layer.

### Embodiment 37

The laminate structure of Embodiment 36, wherein the film is interposed between the base layer and a second layer.

### Embodiment 38

The laminate structure of Embodiment 36, where the film is affixed in a frame.

### Embodiment 39

The laminate structure of Embodiment 38, wherein the frame is attached to a lever or at least two electrodes attached to a control circuit.

### Embodiment 40

A switchable optical laminate comprising a film of any one of Embodiments 1 to 3.

### Embodiment 41

The switchable optical material of Embodiment 40, which forms at least part of a window, roof, skylight, or projector scattering surface.

### Embodiment 42

A process for preparing composite film of any one of Embodiments 1 to 3, the method comprising curing the polysiloxane with the nanoparticles on a substrate.

### Embodiment 43

The process of Embodiment 42, comprising applying the nanoparticles to the substrate and applying uncured polysiloxane over the particles.

### Embodiment 44

The process of Embodiment 42, wherein the nanoparticles do not permanently adhere to the substrate.

### Embodiment 45

The process of Embodiment 42, wherein the polysiloxane fills voids between the particles.

### Embodiment 46

The process of Embodiment 41, wherein the nanoparticles are applied in the presence of a volatile solvent.

### Embodiment 47

The process of Embodiment 46, wherein the volatile solvent is a C₁₋₄ alcohol or polyglycol.

### Embodiment 48

The process of Embodiment 47, wherein the volatile solvent is isopropanol.

### Embodiment 49

The process of Embodiment 46, wherein the volatile solvent comprises about 1 to about 10 wt % of the particles.

### Embodiment 50

The process of Embodiment 42, wherein the polysiloxane is applied in the presence of a cross-linking agent.

### Embodiment 51

The process of Embodiment 50, wherein the weight ratio of polysiloxane to the cross-linking agent is about 10 to about 1.

### Embodiment 52

The process of Embodiment 42, further comprising curing the film.

### Embodiment 53

The process of Embodiment 52, wherein the first layer has a thickness of about 0.5 mm to about 1 mm.

### Embodiment 54

The process of Embodiment 52, wherein the film is removed from the substrate.

### Embodiment 55

A process for modulating light transmission through glass, the method comprising positioning a film of any one of Embodiments 1 to 3 in front or behind the glass.

### Embodiment 56

The process of Embodiment 55, wherein the glass is substantially transparent at a low light illumination.

### Embodiment 57

The process of Embodiment 55, wherein the glass is substantially opaque at a high light illumination.

### Embodiment 58

The process of Embodiment 55, wherein the film is prepared prior to the positioning.

### Embodiment 59

The process of Embodiment 55, wherein the film is prepared on the glass.

### Embodiment 60

The process of Embodiment 55, wherein the film is prepared by: (a) forming a quasi-amorphous silica nanoparticle film on the glass; and (b) forming a poly(dimethylsiloxane) layer on the quasi-amorphous silica nanoparticle film.

### Embodiment 61

A composite film structure comprising the film of any one of Embodiments 1 to 3 superposed on a second film.

### Embodiment 62

The composite film structure of Embodiment 61, wherein the second film is deformable.

### Embodiment 63

The composite film structure of Embodiment 61, wherein the second film is transparent.

### Embodiment 64

A multilayer object comprising at least one layer comprising a film of any one of Embodiments 1 to 3.

The following Examples are provided to illustrate some of the concepts described within this disclosure. While each Example is considered to provide specific individual embodiments of composition, methods of preparation and use, none of the Examples should be considered to limit the more general embodiments described herein.

In the following examples, efforts have been made to ensure accuracy with respect to numbers used (e.g. amounts, temperature, etc.) but some experimental error and deviation should be accounted for. Unless indicated otherwise, temperature is in degrees C., pressure is at or near atmospheric.

### EXAMPLES

SEM images were taken by FEI Quanta Field Emission Gun Environmental SEM in high vacuum mode at an acceleration voltage of 5 kV. The reflectance and scattering spectra at various strains and angles, and the time-dependent transmittance were collected from a USB4000 fiber optical spectrometer (Ocean Optics) combined with a custom-built stretcher and angle-resolved stage. Transmittance of the smart windows at various strains was measured using the Cary 5000 UV-Vis-NIR spectrophotometer (Agilent Technologies) combined with a custom-built stretcher. Optical images were taken by optical microscopy (BX 61, Olympus) in reflection and transmission modes.

In situ confocal microscopy was performed using a laser scanning confocal microscope (Thorlabs, Inc.) in reflection mode using a 635 nm laser source. Mechanical testing using this imaging modality was performed using a custom-built microtensile testing apparatus.

### Example 1: Film Fabrication

Silica (SiO₂) NPs with a diameter of 221 nm, 258 nm and 306 nm were synthesized by St\check{o}ber method as described in West (Liquid-Crystalline Polymers, Vol. 435, Eds: R. A. Weiss, C. K. Ober, American Chemical Society, Washington, D.C. 1990, 475) and Coates (J. Mater. Chem. 1995, 5, 2063), which are both incorporated by reference. The polydispersity of the SiO₂ NPs was less than 8%.

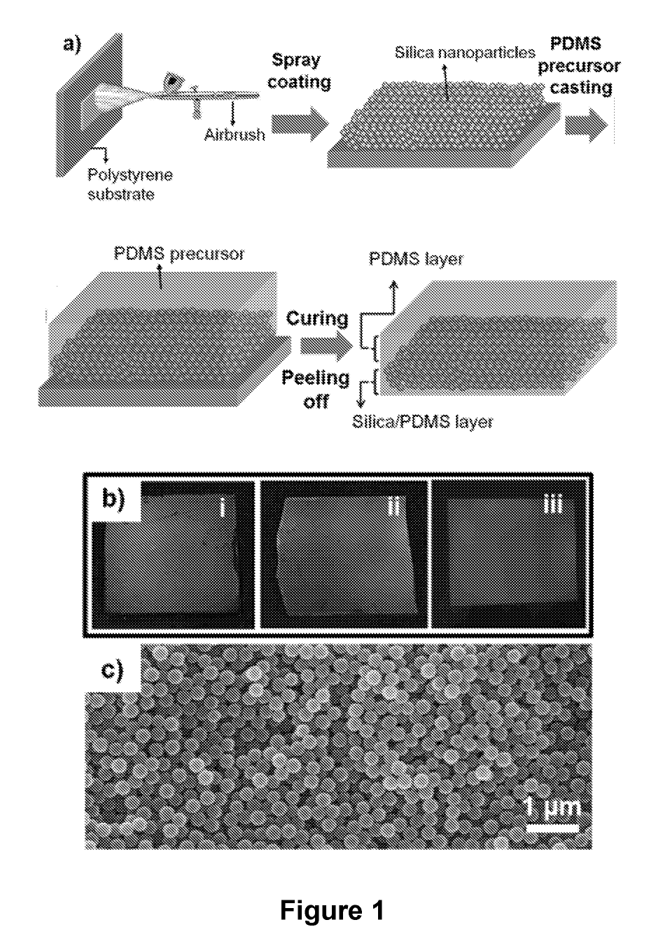

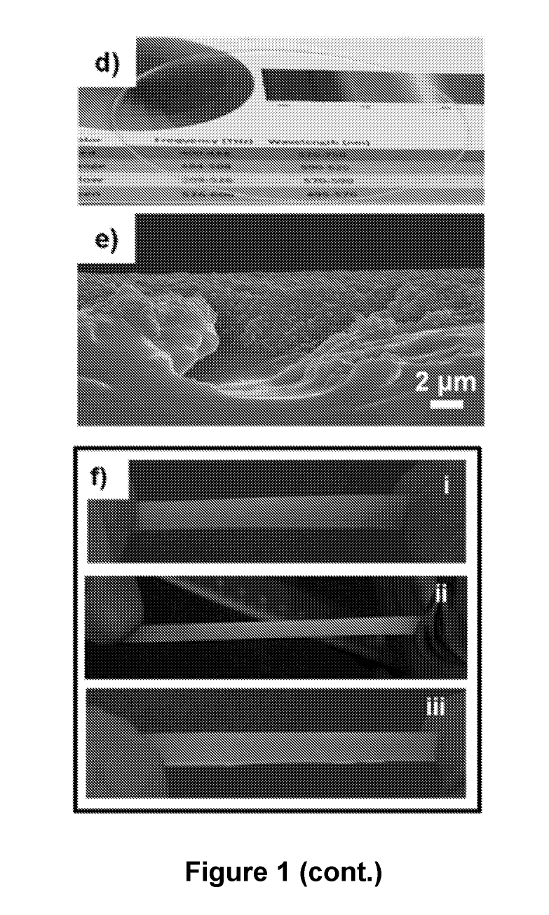

The fabrication of the smart window is illustrated in FIG. 1a. Following the procedure in Ge (Chem. Commun. 2014, 50, 2469), SiO₂ NPs were dispersed into isopropanol (99.8%, Fisher Scientific Inc.) at 10 wt % and ultrasonicated for 2 h (Branson Ultrasonic Cleaner, 2210) to prepare the spray solutions. The spray solution was loaded into an airbrush with nozzle size of 0.2 mm (Master Airbrush Model G44) and the operating pressure was 50 kPa. The solution was sprayed 4 times on the polystyrene (PS) petri dish at a spray distance of 5 cm and a moving speed of about 5 cm/s. Angle-independent blue, green, and pink films (FIG. 1b) were obtained from silica NPs with diameters of 221 nm, 258 nm, and 306 nm, respectively. As shown in scanning electron microscopy (SEM) images, the particles formed quasi-amorphous arrays with short-range ordering yet were long-range disordered (FIG. 1c).

Dow Corning Sylgard® 184 silicone elastomer and curing agent were mixed at a weight ratio 10:1. After degassing, the PDMS precursor was cast on the sprayed PS petri dish, and infiltrated into the voids of the silica NP film. The thickness of the PDMS film was controlled from 0.5 mm to 1 mm. The whole setup was then cured at 65° C. for 4 h. Finally, the hybrid film was carefully peeled from the PS petri dish for stretching. Since the refractive index of PDMS (1.425 at 632.8 nm) is very close to that of silica (1.457 at 632.8 nm), the composite films were highly transparent in the visible and vis-NIR range, as seen in FIG. 1d. Indeed, it is difficult to discern the PDMS films with and without embedded silica NPs.

Under SEM, it was seen that the films had two layers: a thin layer of hard silica NP/PDMS composite (4-5 μm thick) and a bulk layer of pure PDMS (FIG. 1e). The thickness of the pure PDMS layer ranged from 0.5-1 mm depending on the amount of PDMS solution used in casting.

As a control, close-packed silica NP films were prepared for comparison using the procedure described above for the quasi-amorphous silica. The close-packed silica NP films tended to rupture easily at the interface between the composite layer and the pure PDMS layer when peeled off from the supporting substrate due to the narrow PDMS ligments (<20 nm) between the close-packed silica NPs. In comparison, the quasi-amorphous structure of spray-coated NP films possessed rather random, thus larger pores from place to place to infiltrate PDMS. The resulting thicker PDMS layers between the silica NPs offered much higher mechanical strength against macroscopic rupture.

### Example 2: Stretching of Films

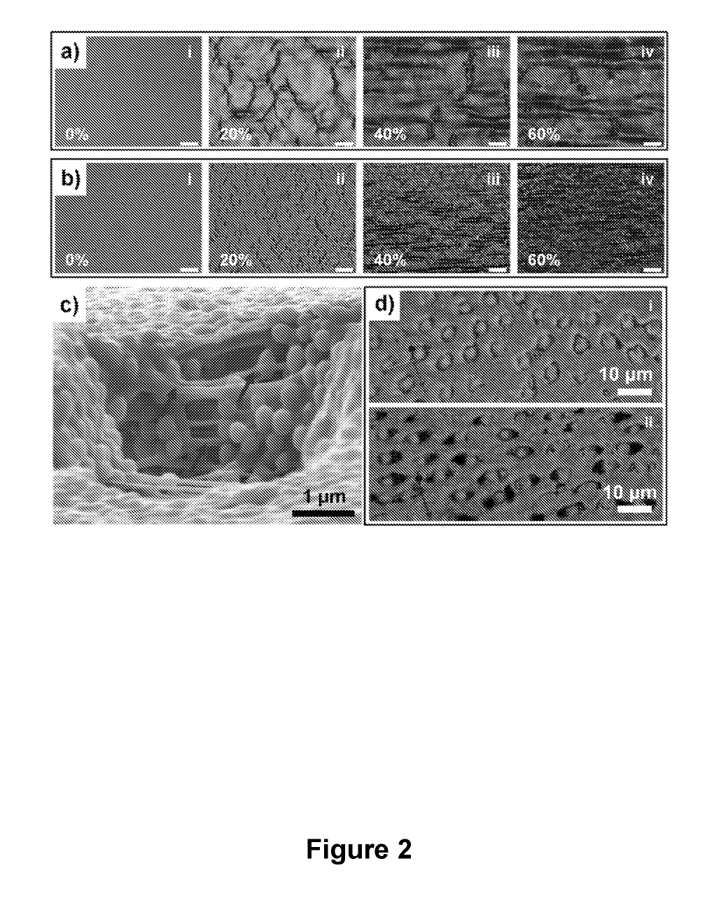

Optical microscopy and SEM were used to monitor the silica NP/PDMS films stretched at various strains (FIGS. 2a-b). Upon stretching, two optical phenomena were observed: 1) switching from transparency to opacity, and 2) appearance of uniform, angle-independent reflective color, blue, green, and yellow-white from the films with silica NPs of diameter 221 nm, 258 nm, and 306 nm, respectively (FIG. 10. These phenomena are reversible upon release of the strains. As seen with optical microscopy in reflectance mode (FIG. 2a), microcracks began to appear (FIG. 2a(ii)) when the strain level reached 20%. With further increase of strain, the number and length of microcracks increased and wrinkling began to occur transverse to the applied strain with wavelength of about 25 μm (FIG. 2a(iii)). The wrinkle formation may be due to mismatch of mechanical properties of the bilayer structure of the silica NP/PDMS composite film. In addition, the optical micrographs taken in reflection mode showed that color appeared randomly in the film. Since the inside of the composite layer could not be imaged clearly under reflection mode, transmission mode was used to image the film instead (FIG. 2b). FIG. 2b(iii-iv) showed that the whole film was yellow/purple-ish, complementary to the reflective color of blue and green seen in FIG. 1f(ii) under transmission mode. However, surface wrinkles and microcracks are not the only reasons contributed to the displayed color. Nanosized voids were also observed from the cross-sectional SEM of the composite film under about 40% strain (FIG. 2c), and PDMS ligaments between the particles were highly stretched, while the silica NPs remained embedded. Voids tended to form locally in high stress regions, rather than across the whole film. To better image the in-plane structure of the composite film and the formation of the voids under mechanical strain, fabricated a PDMS film dispersed with silica particles of larger diameter, 5 μm, was fabricated and imaged the film before and after stretching using confocal microscopy. As seen in FIG. 2d, microvoids were formed on both sides of the silica microparticles parallel to the stretching direction.

### Example 3: Film Transmittance

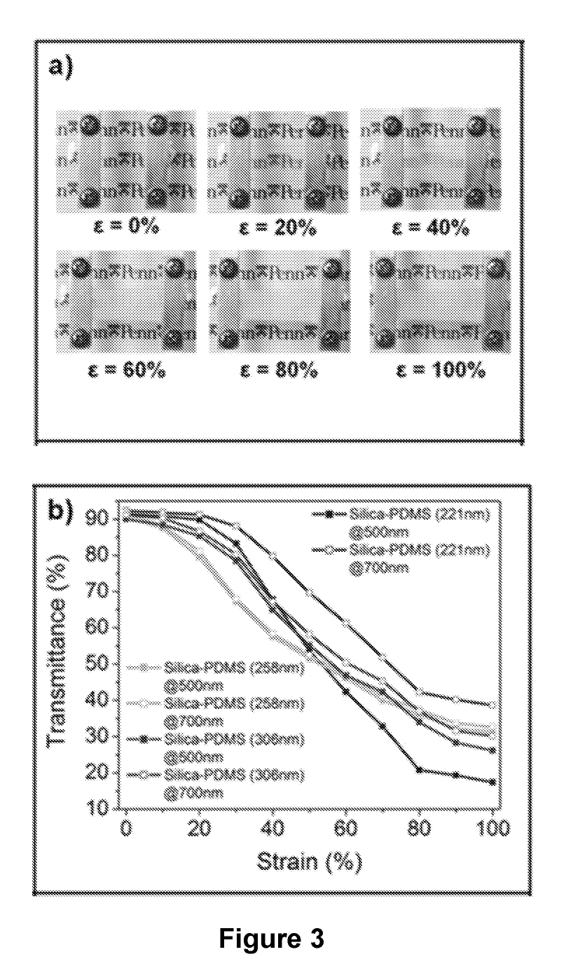

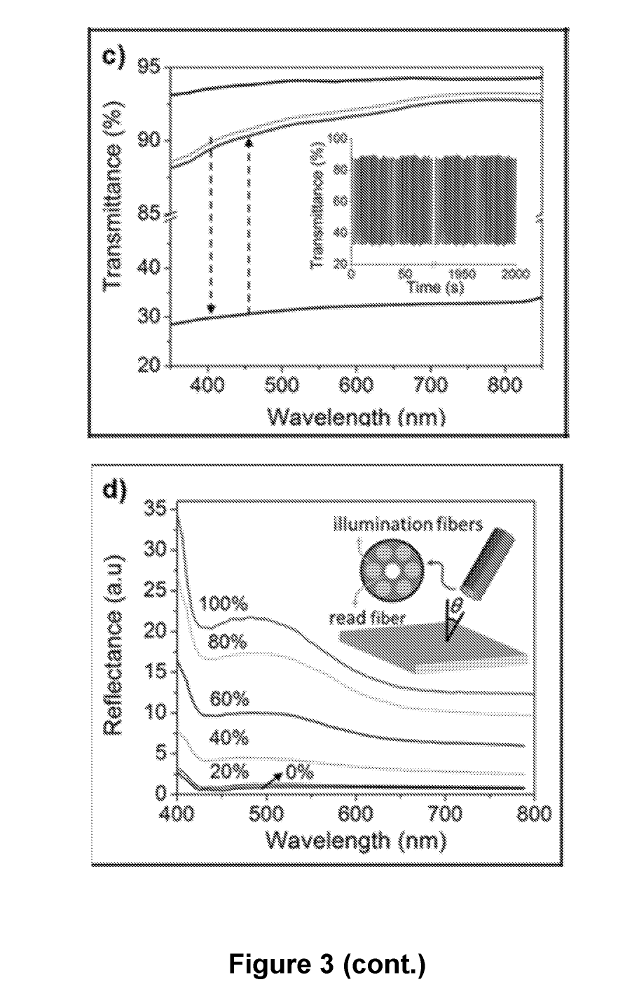

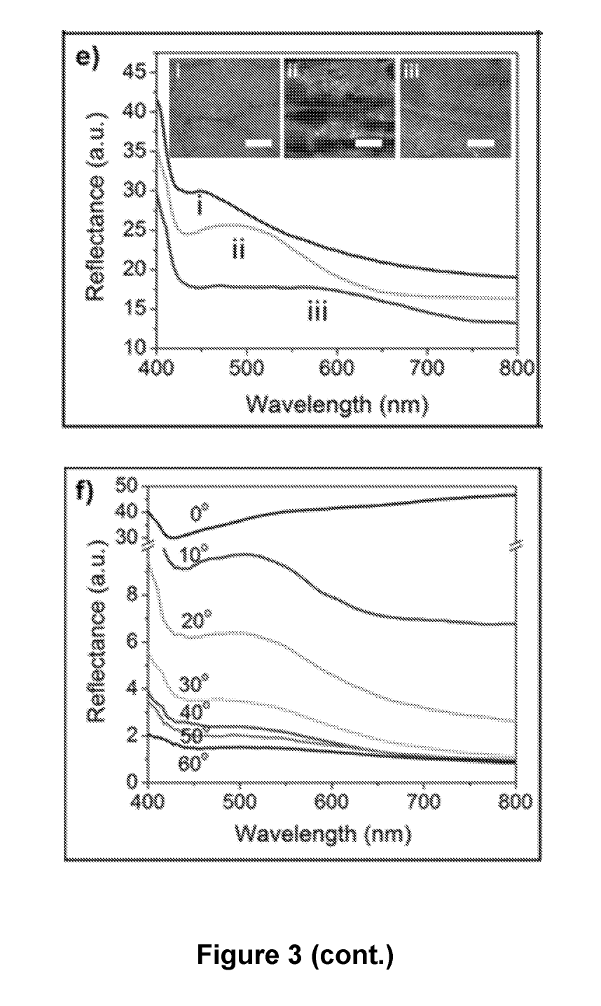

The transmittance of the film prepared in Example 1 was investigated using UV-vis-NIR spectroscopy. By naked eyes, the transparent, as-prepared silica NP/PDMS film began to look translucent at about 20% strain and was completely opaque at about 100% strain (FIG. 3a). The strain-transmittance curves (FIG. 3b) showed three stages, corresponding to wrinkle and crack formation at 0-20% strain level, void formation at 20-80% strain level, and leveling-off at greater than 80% strain, in agreement with observation from optical microscopy shown in FIGS. 2a-b. The transmittance decreased the most at the void formation stage, suggesting that void formation was mainly responsible for the transparency change in the smart window

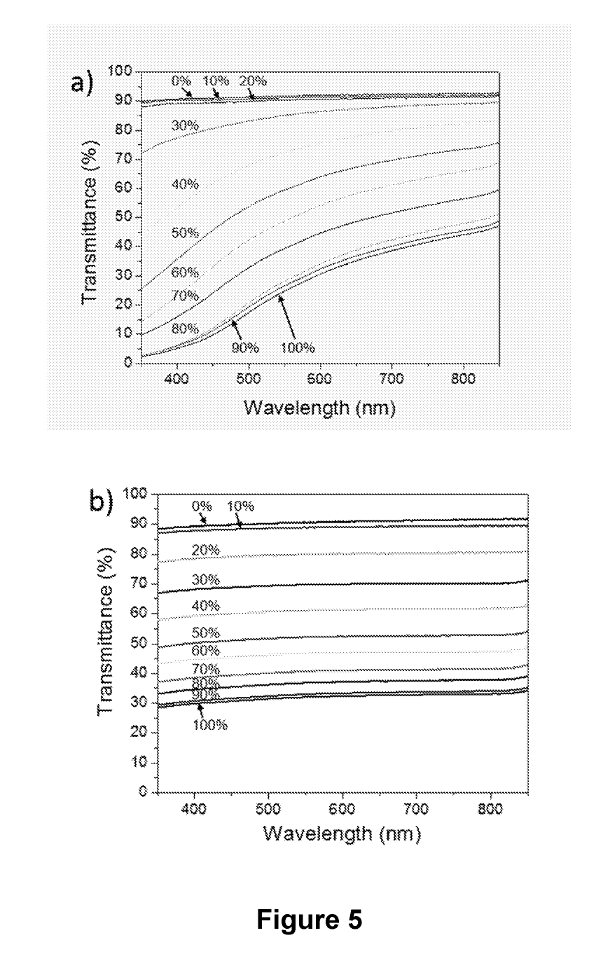

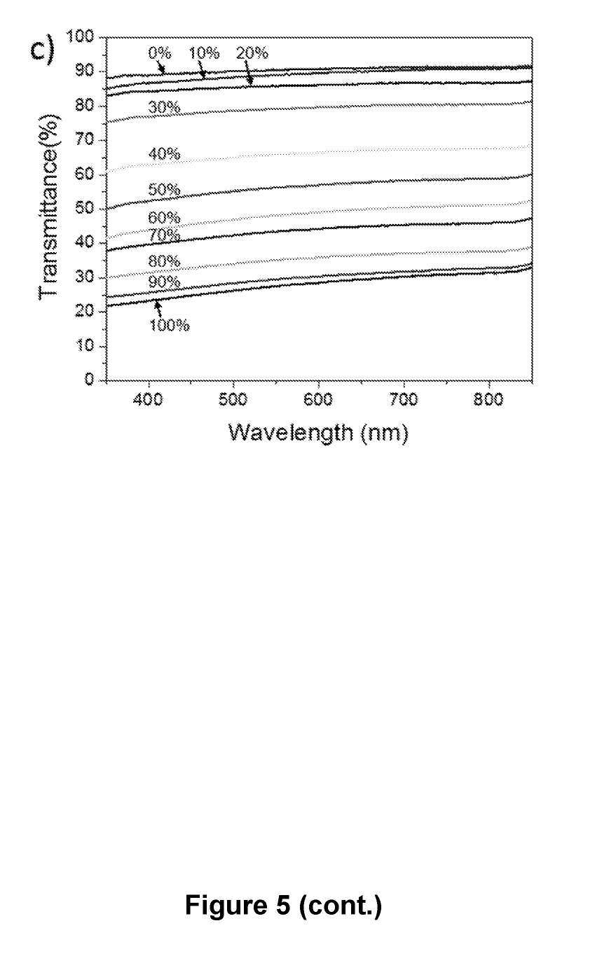

The transmittance is dependent on the size of the silica NPs and thus, the resulting voids from mechanical strain (FIG. 5). Smaller particles (221 nm in diameter) and voids have low transmittance at shorter wavelengths due to Rayleigh scattering, which is wavelength-dependent. Larger particles (258 and 306 nm in diameters) and voids mainly have Mie scattering, which is wavelength-independent. The average transmittance in the visible wavelength range (400-700 nm) of the as-prepared silica NP/PDMS film and a pure PDMS film were measured to be about 92% and about 94%, respectively (FIG. 3c). When stretched, a significantly large drop in the transmittance of the silica NP/PDMS film in the visible region was observed (FIGS. 3c and 5): over 50% in average for different particle sizes and the largest change was nearly 70%, much higher than those reported in literature.

### Example 4: Repeatability and Robustness of the Films

To demonstrate repeatability and robustness, the films were stretched and released from 20% to 70% strain at a frequency of 0.5 Hz for 1000 times, and the transparency was measured continuously at 500 nm. The transmittance of the films after stretching and releasing 1000 times was nearly identical to that of the un-stretched film (FIG. 3b inset). It is hypothesized that the durability and stability of the films can be attributed to the combination of thick PDMS layer (0.5-1 mm) and thin silica NP/PDMS composite layer (about 4-5 μm). While the top thin layer may be responsible for color/transmittance change, the bottom thick PDMS layer produced necessary restoring force for the entire film for repeated stretching and release. Meanwhile, the elastic PDMS nanoscale ligaments generated during stretching in the composite layer (FIG. 2c) played a role to confine the silica NPs in their local regions, where color appeared and intensified upon stretching but did not change for a given NP size.

### Example 5: Color Characterization of the Films

To characterize the color of the films prepared in Example 1, the reflectance of the films at different strain levels in the vis-NIR range was measured using a custom-built spectrophotometer outfitted with a reflectance and backscattering optical fiber (Ocean Optics), as shown in the FIG. 3d inset. Reflectance peaks started to appear at 40% strain and intensified at strains greater than 60% (FIG. 3d), which matched the formation of microwrinkles and nanovoids shown in FIG. 2. The peak position did not noticeably change with increase of strain.

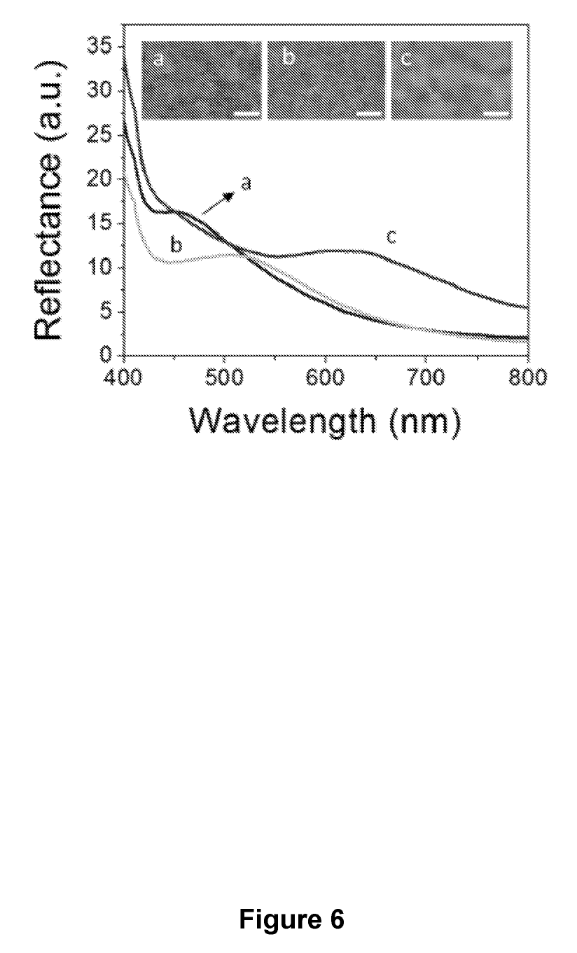

It is noted that the color of quasi-amorphous silica NP array (FIGS. 1b and 6), however, is different from that of silica NP/PDMS film (FIGS. 1f and 3e) of the same NP size. As seen in FIG. 6, the reflectance peaks (λ_{R}) of the silica NP arrays were dependent on the size of NPs: blue (NP diameter, 221 nm), green (258 nm) and pink (306 nm) films had reflectance peaks at 46 nm, 517 nm, 625 nm, respectively. At 80% strain and a viewing angle of 10°, the reflectance peaks of the films prepared with 221 nm, 258 nm, and 306 nm silica NPs were at wavelengths 454 nm, 501 nm, and 587 nm, respectively (FIG. 3e). The reflectance peaks of the stretched silica NP/PDMS films were blue-shifted compared to pure NP films of the same NP size, but there was no further change of peak position at various strains.

The films were then tilted with respect to the detector. As seen in FIG. 3f, the reflectance peak positions did not change with the viewing angles, characteristic of quasi-amorphous structural color. Instead, the reflectance peak intensity is dependent on the viewing angle and maximized at a viewing angle of 10°. In contrast, optically switchable windows reported in literature typically produce angle-dependent color due to Bragg diffraction of the highly-ordered structures.

### Example 6: Mechanistic Considerations

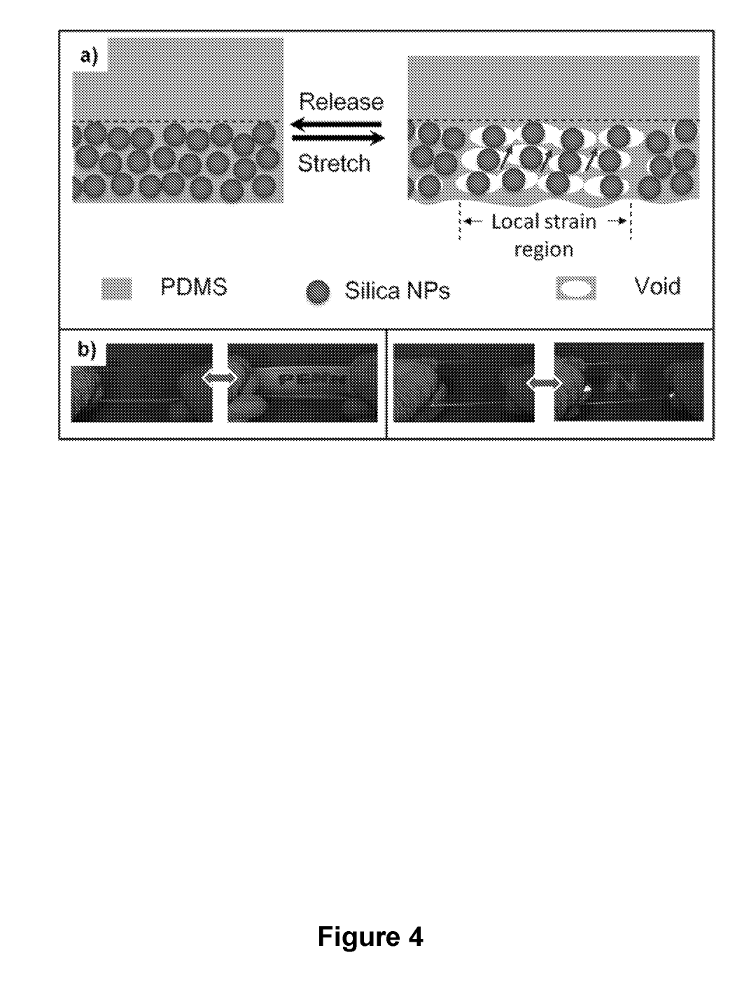

Based on the aforesaid information and data presented in the examples below, the inventors hypothesize a mechanism of void formation in FIG. 4a, where the changes in the optical properties could be attributed to the microstructural change, including micro-roughness from wrinkles and nano-voids formed between PDMS and silica NPs (FIGS. 2a-b). The void formation led to new reflection interfaces (i.e. void/silica, void/PDMS, FIGS. 2c-d) and a dramatic increase (over 200 times) in the reflectance at the interface (0.014% to about 3.05-3.45%), and thus, a significant drop in transparency.

A. Reflectance at the Interface

The reflectance at the interface between two media under the normal incident light is

$$R = \frac{{( {n}_{1} - {n}_{2} )}^{2}}{{( {n}_{1} + {n}_{2} )}^{2}} \qquad ( 1 )$$

where n₁ and n₂ are the refractive indices of media 1 and media 2.

As seen in FIG. 4a, there were three interfaces in the stretched silica/PDMS composite film: silica/PDMS interface, silica/void interface, and PDMS/void interface. Here, n_{silica}=1.457 at 632.8 nm, n_{PDMS}=1.423 at 632.8 nm, and n_{void}=1. The reflectance at the interfaces is R_{silica/PDMS}=0.014%, R_{silica-void}=3.46%, and R_{PDMS-void}=3.05%.

Mechanical strain caused the thinning of the silica NP/PDMS composite film due to the positive Poisson's ratio of PDMS, 0.5. Since the top layer of silica NP/PDMS was much thinner than the bottom PDMS bulk layer, the thinning of the composite film mainly occurred in the bulk PDMS layer. Thus, the interplanar spacing (dₚₗₐₙₐᵣ) of NP assembly did not change much with the strain, while location of voids correlated to the silica NP positions (FIGS. 2c-d). The void arrangements formed locally were also quasi-amorphous, analogous to the quasi-amorphous silica NP arrays, which were somewhat locked by the adjacent PDMS layer. Thus, the angle-independent structural color of the stretched films was the result of the quasi-amorphous structures consisting of voids and silica NPs.

As previously discussed, voids occurred locally at the high stress positions, and the local strain, obtained from the SEM images (FIG. 2c), was on the order of 100% even at a relatively low global strain level. Based on the model in FIG. 4a, the local volume filling fraction of voids (f_{void}) is calculated as about 0.4, higher than that of air, fₐᵢᵣ=0.35, of the sprayed quasi-amorphous array of NPs.

B. Reflection Peaks

Typically, the reflection peaks λR of colloidal crystals are angle dependent and can be explained by the Bragg-Snell law:

λ_{R}=2dₚₗₐₙₐᵣ(n_{eff}²−sin²θ)^{1/2} (2)

where dₚₗₐₙₐᵣ is the interplanar spacing, n_{eff} is the effective refractive index, and θ is the incidental angle. The reflection peaks of quasi-amorphous arrays of nanoparticles are angle independent.

According to Ge (J. Mater. Chem. C, 2014, 2:4395), the reflection peaks λ_{R} of quasi-amorphous arrays are linearly proportional to the silica nanoparticle size (D_{silica}) and can be calculated as:

λ_{R}=∝D_{silica}=2dₚₗₐₙₐᵣn_{eff} (3)

Taking θ=0° in Equation 2, the factor a as 2.04 was obtained for quasi-amorphous nanoparticle arrays, and 2.18 for face-centered cubic (FCC) colloidal crystals.

For the pure silica nanoparticle arrays, the effective refractive index n_{eff} is

n_{eff}=f_{silica}n_{silica}+fₐᵢᵣnₐᵢᵣ (4)

where f is the volume filling fraction. Here, f_{silica}+fₐᵢᵣ=1, n_{silica}=1.457 and nₐᵢᵣ=1, so

λ_{R}=2dₚₗₐₙₐᵣ(1.457−0.457fₐᵢᵣ) (5)

For the silica nanoparticle/PDMS composite layer, n_{eff} is

n_{eff}=f_{PDMS}n_{PDMS}+f_{silica}n_{silica}+f_{void}n_{void} (6)

The ratio of the volume filling fraction of the sprayed quasi-amorphous particle array to PDMS is f_{silica}:f_{PDMS}=0.35:0.65. Here f_{silica}+f_{PDMS}+f_{void}=1, n_{silica}=1.457, n_{PDMS}=1.423 and n_{void}=1, so

λ_{R}=2dₚₗₐₙₐᵣ(1.445−0.445f_{void}) (7)

The void volume filling fraction (f_{void}) can be estimated based on the model shown in FIG. 4a. Here, the void is assumed as a perfect ellipsoid and a silica particle is embedded in the

$${v}_{void} = \frac{4}{3} π {ar}^{2} - \frac{4}{3} π {r}^{3} = \frac{( a - r )}{r} {V}_{silica} \qquad ( 8 )$$

The void volume filling fraction is

$${f}_{void} = \frac{{V}_{void}}{{V}_{void} + {V}_{silica} + {V}_{PDMS}} \qquad ( 9 )$$

Particles are near close-packed, so the edge PDMS thickness (b) is very small comparing to the particle diameter. Here b is ignored, the strain is ε=(a−r)/r and V_{PDMS}:V_{silica}=0.65:0.35.

Therefore,

$${f}_{void} = \frac{0.65 ɛ}{0.65 ɛ + 1} \qquad ( 10 )$$

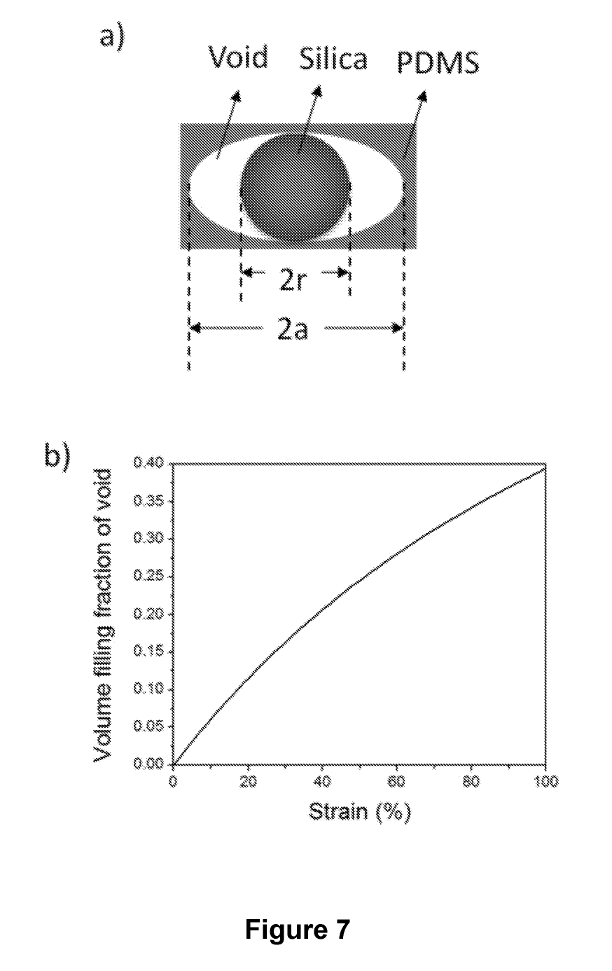

The ε-f_{void} curve is shown in FIG. 7b. When strain is larger than 80%, f_{void}>0.35.

These results suggested that the local strain applied to the thin NP/PDMS layer was not equivalent to the global strain applied to the whole film; cracking/wrinkling and nanovoids occur to relax the local strain despite the continuing straining of the bulk PDMS layer. Therefore, the reflection peak position did not change with the increase of applied strain, while the peak intensity increased (FIG. 3d) due to the increase in the number of voids. Likewise, blue-shift of the reflection peaks of stretched silica NP/PDMS film vs. the as-prepared silica NP arrays can be explained by the decrease of dₚₗₐₙₐᵣ and increase off f_{void} according to Equations 5 and 7.

### Example 7: Fabrication of a Smart Window with Embedded Letters

A solid mask of “PENN” and a hollow mask of “N” were prepared from cut paper. The mask was placed on the petri dish, followed by spray coating of silica NPs as described in Example 1. After removal of the mask, PDMS precursor was cast on the petri dishes following the same procedure to fabricate the hybrid window described in Example 1.

As seen in FIG. 4b, hidden letters “PENN” (negative) and “N” (positive) were reversibly revealed upon stretching and releasing of the film

It is to be understood that while the invention has been described in conjunction with the preferred specific embodiments thereof, that the foregoing description and the examples that follow are intended to illustrate and not limit the scope of the invention. It will be understood by those skilled in the art that various changes may be made and equivalents may be substituted without departing from the scope of the invention, and further that other aspects, advantages and modifications will be apparent to those skilled in the art to which the invention pertains. In addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

The disclosures of each patent, patent application, and publication cited or described in this document are hereby incorporated herein by reference, each in its entirety, for all purposes.

1. A composite film comprising a polysiloxane and nanoparticles, wherein the nanoparticles and polysiloxane have substantially similar refractive indices, but a different Young's modulus of at least one order of magnitude;
the film reversibly exhibiting different degrees of transparency depending on a stress applied to the film in the plane of the film, wherein the film transmits at least 90% of light in a first, less stressed state and the film transmits less light in a second, more stressed state than when in the first state.

2. A composite film comprising nanoparticles embedded within a polysiloxane, the film having first and second surfaces, the nanoparticles being concentrated closer to the first surface than the second surface, wherein the nanoparticles and polysiloxane have matched refractive indices within 5%;
the film reversibly exhibiting different degrees of transparency depending on a stress applied to the film in the plane of the film, such that when in a first, less stressed state, the film transmits at least 90% (average in the visible wavelength range) of incident light, and when in a second, more stressed state, the film transmits less light than when in the first state.

3. A reversibly deformable and transparency-modifiable film comprising a first layer of poly(dimethylsiloxane) and a second layer of poly(dimethylsiloxane) impregnated with silica nanoparticles.

4. The film according to claim 1, wherein said polysiloxane is lightly cross-linked.

5. (canceled)

6. The film according to claim 1, wherein said polysiloxane is a poly(dimethylsiloxane).

7. (canceled)

8. (canceled)

9. The film according to claim 1, wherein said nanoparticles are silica particles, polystyrene particles, poly(methyl methacrylate) particles, or a combination thereof.

10. The film according to claim 9, wherein said silica particles are functionalized with hydrophobic groups.

11. The film according to claim 10, wherein said hydrophobic groups comprise —(CH₂)ₙ(CF₂)ₘCF₃, —(CH₂)ₙCH₃ and aromatic moieties.

12. The film according to claim 1, having first and second surfaces, wherein the nanoparticles are concentrated closer to the first surface than the second surface.

13. (canceled)

14. (canceled)

15. The film according to claim 12, wherein said second layer has a thickness of about 2 to about 20 μm.

16. The film according to claim 12, wherein said first layer has a thickness of about 0.1 to about 1 mm.

17. (canceled)

18. (canceled)

19. The film according to claim 1, which transmits at least about 90% of light at a wavelength of about 400 nm to about 1000 nm at 0% strain.

20. The film according to claim 1, wherein said nanoparticles have a diameter of about 100 nm to about 5 μm.

21. (canceled)

22. (canceled)

23. (canceled)

24. (canceled)

25. The film according to claim 1, further comprising a piezoelectric agent.

26. (canceled)

27. (canceled)

28. (canceled)

29. (canceled)

30. (canceled)

31. (canceled)

32. (canceled)

33. (canceled)

34. (canceled)

35. (canceled)

36. A laminate structure comprising a substantially transparent base layer and a film of claim 1 adjacent to said base layer.

37. The laminate structure according to claim 36, wherein said film is interposed between said base layer and a second layer.

38. (canceled)

39. (canceled)

40. (canceled)

41. (canceled)

42. A process for preparing composite film of claim 1 to 3, said method comprising curing said polysiloxane with said nanoparticles on a substrate.

43. The process according to claim 42, comprising applying said nanoparticles to said substrate and applying uncured polysiloxane over said particles.

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. A process for modulating light transmission through glass, said method comprising positioning a film of claim 1 in front or behind said glass.

56. (canceled)

57. (canceled)

58. The process according to claim 55, wherein said film is prepared prior to said positioning.

59. The process according to claim 55, wherein said film is prepared on said glass.

60. The process according to claim 55, wherein said film is prepared by:
(a) forming a quasi-amorphous silica nanoparticle film on said glass; and
(b) forming a poly(dimethylsiloxane) layer on said quasi-amorphous silica nanoparticle film.

61. (canceled)

62. (canceled)

63. (canceled)

64. (canceled)
